(19) United States
(12) Patent Application Publication
(10) Pub. No.: US 2017/0061344 A1
(43) Pub. Date: Mar. 2, 2017

(54) IDENTIFYING AND MITIGATING CUSTOMER CHURN RISK

(71) Applicant: LinkedIn Corporation, Mountain View, CA (US)

(72) Inventors: Zhaoying Han, Mountain View, CA (US); Juan Wang, Los Altos, CA (US); Song Lin, Santa Clara, CA (US); Xing Zhou, Mountain View, CA (US); Qiang Zhu, Sunnyvale, CA (US); SangHyun Park, Fremont, CA (US); Yurong Shi, San Jose, CA (US); Luke Thomas Whelan, Dublin (IE)

(73) Assignee: LinkedIn Corporation, Mountain View, CA (US)

(21) Appl. No.: 14/841,547

(22) Filed: Aug. 31, 2015

(51) Int. Cl. G06Q 10/06; G06F 3/0481; G06F 3/0484; G06T 11/20

(52) U.S. Cl. CPC G06Q 10/0635; G06T 11/206; G06F 3/04812; G06F 3/0484

(57) ABSTRACT

The disclosed embodiments provide a system for processing data. During operation, the system obtains a set of data for a set of customers of a product, wherein the set of data comprises a set of churn risk levels for the customer. Next, the system uses the set of data to display a graphical user interface (GUI) comprising a chart of renewal opportunities with the set of customers, for the product, over an upcoming time interval. The system then displays, in the GUI, a representation of a churn risk level for each customer in the set of customers with a renewal opportunity in the chart.

### RELATED APPLICATION

The subject matter of this application is related to the subject matter in a co-pending non-provisional application by the same inventors as the instant application and filed on the same day as the instant application, entitled “Predicting Churn Risk Across Customer Segments,” having serial number TO BE ASSIGNED, and filing date TO BE ASSIGNED (Attorney Docket No. LI-P1531.LNK.US).

### BACKGROUND

Field

The disclosed embodiments relate to techniques for managing customer churn. More specifically, the disclosed embodiments relate to techniques for identifying and mitigating customer churn risk.

Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a schematic of a system in accordance with the disclosed embodiments.

FIG. 2 shows a system for processing data in accordance with the disclosed embodiments.

FIG. 3A shows an exemplary screenshot in accordance with the disclosed embodiments.

FIG. 3B shows an exemplary screenshot in accordance with the disclosed embodiments.

FIG. 3C shows an exemplary screenshot in accordance with the disclosed embodiments.

FIG. 4 shows a flowchart illustrating the processing of data in accordance with the disclosed embodiments.

FIG. 5 shows a flowchart illustrating the process of providing a graphical user interface (GUI) on a computer system in accordance with the disclosed embodiments.

FIG. 6 shows a flowchart illustrating the process of obtaining a set of churn risk levels for a set of customers of a product in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

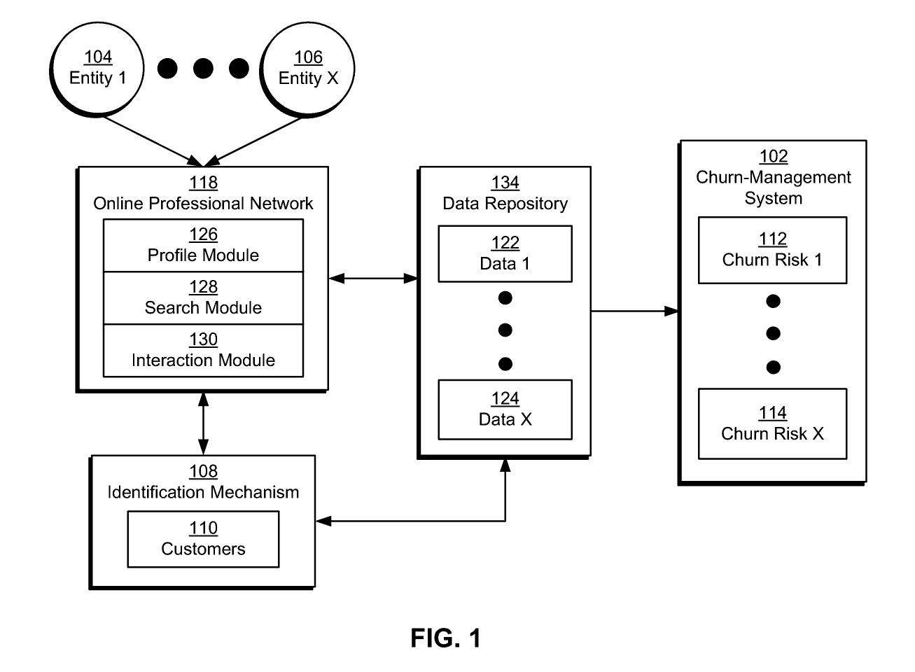

The disclosed embodiments provide a method, apparatus, and system for processing data. More specifically, the disclosed embodiments provide a method, apparatus, and system for managing the churn risk of customers in a social network. As shown in FIG. 1, the social network may be an online professional network 118 that allows a set of entities (e.g., entity 1104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use online professional network 118 to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills Profile module 126 may also allow the entities to view the profiles of other entities in online professional network 118.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or newsfeed that provides the latest postings, articles, and/or updates from the entities' connections and/or groups to the entities. Similarly, online professional network 118 may include mechanisms for recommending connections, job postings, articles, and/or groups to the entities.

In one or more embodiments, data (e.g., data 1122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

The entities may also include a set of customers 110 that purchase products through online professional network 118. For example, customers 110 may include individuals and/or organizations with profiles on online professional network 118. As a result, customers 110 may use online professional network 118 to interact with professional connections, list and apply for jobs, establish professional brands, and/or conduct other activities in a professional and/or business context.

Customers 110 may also be targeted for marketing or sales activities by other entities in online professional network 118. For example, customers 110 may be companies that purchase business products and/or solutions that are offered by online professional network 118 to achieve goals related to hiring, marketing, advertising, and/or selling. In another example, customers 110 may be individuals and/or companies that are targeted by marketing and/or sales professionals through online professional network 118.

As shown in FIG. 1, customers 110 may be identified by an identification mechanism 108 using data from data repository 134 and/or online professional network 118. For example, identification mechanism 108 may identify customers 110 by matching profile data, group memberships, industries, skills, customer relationship data, and/or other data for customers 110 to keywords related to products that may be of interest to the customers. As a result, customers 110 may include entities that have purchased products through and/or within online professional network 118, as well as entities that have not yet purchased but may be interested in products offered through and/or within online professional network 118.

Identification mechanism 108 may also match customers 110 to products using different sets of criteria. For example, identification mechanism 108 may match customers in recruiting roles to recruiting solutions, customers in sales roles to sales solutions, customers in marketing roles to marketing solutions, and customers in advertising roles to advertising solutions. If different variations of a solution are available, identification mechanism 108 may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, customers 110 may include all entities in online professional network 118, which may be targeted with products such as “premium” subscriptions or memberships with online professional network 118.

After customers 110 are identified, they may be targeted by one or more or sales professionals with relevant products. For example, the sales professionals may engage customers 110 with recruiting, marketing, sales, and/or advertising solutions that may be of interest to the customers. After a sales deal is closed with a given customer, a sales professional may follow up with the customer to improve the customer lifetime value (CLV) and retention of the customer. On the other hand, the customer may fail to renew the sales deal or renew at a lower amount if the customer fails to obtain adequate value from the product and/or feels that the renewal price is too high. In other words, the customer may churn from the product if the sales professional is unable to communicate or increase the value of the product to the customer.

In one or more embodiments, the system of FIG. 1 includes functionality to predict, manage, and mitigate churn risk (e.g., churn risk 1112, churn risk x 114) in customers 110 who have signed sales deals for products through online professional network 118. More specifically, a churn-management system 102 may use data from data repository 134 to identify customers with high levels of churn risk. As described in further detail below, churn-management system 102 may also identify risk factors associated with the churn risk, generate notifications of the high churn risk levels and/or risk factors, and/or provide mechanisms for identifying and mitigating the high churn risk levels. Consequently, churn-management system 102 may improve customer retention and CLV for products that are marketed and/or sold through online professional network 118.

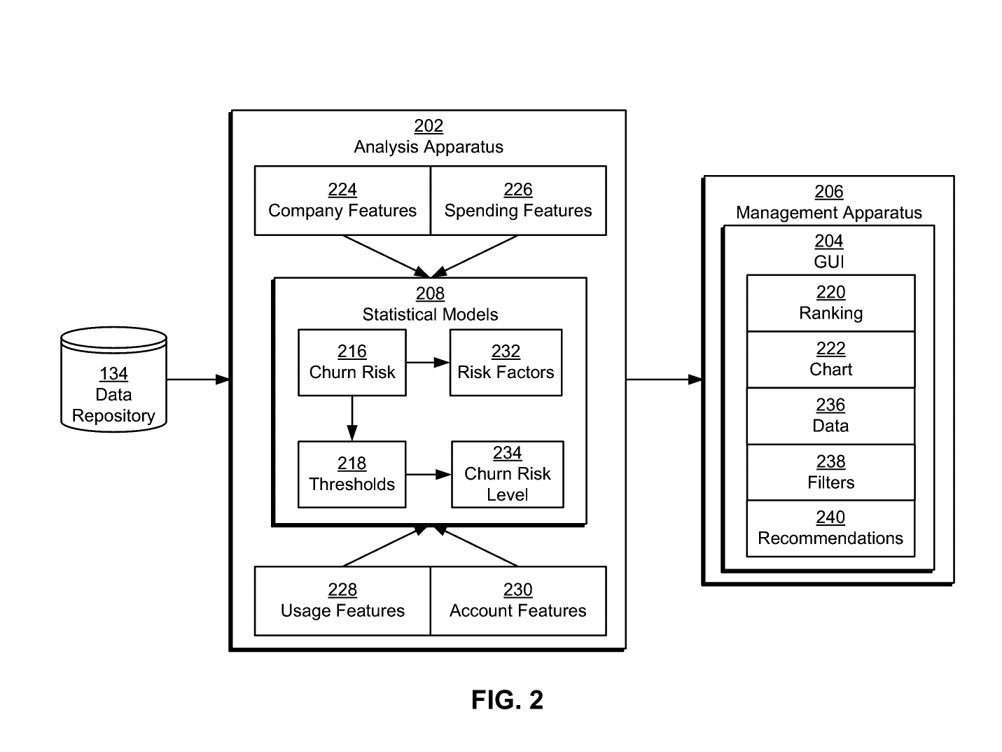

FIG. 2 shows a system for processing data in accordance with the disclosed embodiments. More specifically, FIG. 2 shows a system for predicting and managing churn risk 216 for a number of customers (e.g., customers 110 of FIG. 1), such as churn-management system 102 of FIG. 1. As shown in FIG. 2, the system includes an analysis apparatus 202 and a management apparatus 206. Each of these components is described in further detail below.

Analysis apparatus 202 may predict churn risk 216 for each customer of a product. Churn risk 216 for a given customer may represent that customer's likelihood of fully or partially churning from the product. A full churn may occur when the customer fails to renew with a product such as a business, sales, talent, and/or marketing solution with an online professional network (e.g., online professional network 118 of FIG. 1). A partial churn may occur when the customer renews with the product at an amount that is less than a proportion (e.g., 85%) of the customer's “renewal target amount,” which represents a target dollar amount for the customer's next renewal with the product.

As described above, the customer may be a current and/or prospective customer that is identified using data from data repository 134. Analysis apparatus 202 may also use data from data repository 134 to generate a set of features for the customer, including one or more company features 224, one or more spending features 226, one or more usage features 228, and one or more account features 230. For example, analysis apparatus 202 may use one or more queries to obtain the features directly from data repository 134, extract one or more features from the queried data, and/or aggregate the queried data into one or more features.

Company features 224 may include attributes and/or metrics associated with a customer that is a company (or other type of organization). Company features 224 may include demographic attributes such as a location, an industry, a company type (e.g., corporate, staffing, etc.), an age, and/or a size (e.g., small business, medium/enterprise, global/large, etc.) of the company. One or more company features 224 may also be used to identify a company segment of the customer. For example, the company segment to which the customer belongs may include the company's location, size, and/or type.

Spending features 226 may relate to the customer's spending behavior or spending history with the product. For example, spending features 226 may include the renewal target amount, which may be set to the customer's most recent spending amount. The renewal target amount may also be set to other values, such as an average spending amount for the customer and/or other customers in the same company segment, or the customer's most recent spending amount, any of which may be multiplied by a factor. Spending features 226 may also include metrics such as the customer's previous spending amounts, discount rates associated with the customer's spending amount, and/or spending growth that tracks a trend in the customer's spending amounts over time. As with company features 224, spending features 226 may include attributes and/or metrics that are relevant to the product. For example, spending features 226 for predicting the customer's churn risk 216 for a recruiting solution may include a number of recruiting spots and/or job posting slots purchased by the customer with the recruiting solution.

Usage features 228 may identify the customer's usage of the online professional network through which the product is purchased or used. For example, usage features 228 may include metrics related to the customer's level of activity on the online professional network, such as a number of searches, messages sent, profile views, profile updates, company updates, and/or visits to the online professional network by the customer. The metrics may be aggregated into an engagement score for the company that is included in usage features 228 with the metrics or as a substitute for the metrics. Usage features 228 may also relate to the customer's usage of the product. For example, usage features 228 for predicting the customer's churn risk 216 for a recruiting solution may include a number of job listings, hires through the job listings, and/or new hires made by the customer. Usage features 228 associated with a recruiting solution may also include one or more flags representing the customer's activation or use of one or more features in the product, such as a “career page” that provides information about careers and job openings with the customer.

Account features 230 may characterize the customer from a sales perspective. For example, account features 230 may include a potential spending amount that represents the most the company can spend on the product, given the company's size and needs. Account features 230 may also identify the stage of the sales renewal cycle occupied by the customer. For example, the customer's stage in a yearly sales renewal cycle may be “onboard,” or newly signed; in the first, second, or third quarter after signing; or in the 11^{th} month after signing. Account features 230 may also include attributes and/or metrics that are relevant to the product. For example, account features 230 for predicting the customer's churn risk 216 for a recruiting solution may include the number of recruiters, number of talent professionals (e.g., human resources staff), and/or size of the staffing department in the company.

After company features 224, spending features 226, usage features 228, and account features 230 are obtained, analysis apparatus 202 may use one or more of the features to select one or more statistical models 208 for predicting churn risk 216 for the customer. Analysis apparatus 202 and/or another component of the system may create and maintain a set of statistical models 208 that predict churn risk 216 for different subsets of customers. Each statistical model may be trained and/or updated on a periodic basis (e.g., daily) using data associated with the corresponding subset of customers from data repository 134. For example, statistical models 208 may be trained to predict churn risk 216 for different combinations of company segments (e.g., size, location, type) and stages in the sales renewal cycle.

As a result, churn risk 216 may be predicted for the customer by selecting a first statistical model that matches the company segment, its stage in the sales renewal cycle, and/or other features of the customer, and then inputting one or more company features 224, spending features 226, usage features 228, and/or account features 230 into the statistical model. In turn, the first statistical model may generate a prediction of churn risk 216 and one or more thresholds 218 associated with churn risk 216.

As described above, churn risk 216 may be a numeric score or value that represents the customer's propensity for fully or partially churning from the product. Because churn risk 216 may be assessed in relation to other values of churn risk 216 for other customers, thresholds 218 may represent values that indicate certain levels of churn risk 216, such as medium, medium-high, or high. For example, thresholds 218 may be set to values that represent certain percentiles of churn risk 216 for the company segment and stage in the sales renewal cycle of the customer.

The first statistical model and/or analysis apparatus 202 may also apply thresholds 218 to churn risk 216 to identify a churn risk level 234 for the customer. For example, churn risk level 234 may be set to high if churn risk 216 exceeds a threshold for high churn risk. If churn risk 216 is below the threshold for high churn risk and above the threshold for a medium-high churn risk, churn risk level 234 may be set to medium-high. If churn risk 216 is below the threshold for medium-high churn risk and above the threshold for a medium churn risk, churn risk level 234 may be set to medium. If churn risk 216 is below the threshold for medium churn risk, churn risk level 234 may be set to low.

Analysis apparatus 202 may also use statistical models 208 to identify one or more risk factors 232 associated with churn risk 216. Risk factors 232 may include attributes of the customer that increase churn risk 216. To determine if the customer is associated with a given risk factor, analysis apparatus 202 may use a second statistical model to compare one or more features of the customer with one or more thresholds for the risk factor. When the feature does not meet the threshold, the risk factor may be found in the customer.

Analysis apparatus 202 may identify churn risk 216, thresholds 218, risk factors 232, and churn risk level 234 for a number of customers, such as customers associated with certain company segments and/or stages of the sales renewal cycle. Management apparatus 206 may then use churn risk 216, thresholds 218, risk factors 232, and/or churn risk level 234 to mitigate high churn risk levels in a subset of the customers. For example, management apparatus 206 may generate one or more emails, messages, alerts, and/or other notifications of high churn risk levels and/or risk factors 232 for the subset of the customers. Management apparatus 206 may also transmit communications containing content for reducing the high churn risk levels to the customers, such as emails, presentations, documents, or messages that include information for increasing value, improving product usage, and/or otherwise alleviating one or more risk factors 232 of the customers. Management apparatus 206 may further provide any identified risk factors 232 for all customers, including customers with low churn risk.

Information associated with churn risk 216, thresholds 218, risk factors 232, and churn risk level 234 may additionally be displayed within a graphical user interface (GUI) 204 by management apparatus 206, along with user-interface elements in GUI 204 for searching, sorting, filtering, updating, and/or exporting the information. First, management apparatus 206 may display a ranking 220 of customers sorted by one or more attributes within GUI 204. For example, management apparatus 206 may include 100 or 500 customers with the highest renewal target amounts and/or churn risk 216 in ranking 220.

Second, management apparatus 206 may display a chart 222 in GUI 204, such as a chart of renewal opportunities for the customers. Within chart 222, each renewal opportunity may be associated with a representation of the corresponding churn risk level. For example, representations of renewal opportunities in chart 222 may be color-coded to indicate the churn risk levels of the customers associated with the renewal opportunities.

Third, management apparatus 206 may display data 236 associated with churn risk 216, thresholds 218, risk factors 232, and churn risk level 234 within ranking 220, chart 222, and/or other parts of GUI 204. For example, data 236 may include the customer names, locations, renewal target amounts, and/or renewal dates of customers in ranking 220 and/or chart 222. Data 236 may also include risk factors 232 for high churn risk levels of the customers and/or criteria (e.g., thresholds) for identifying risk factors 232. Data 236 may further be aggregated into statistics for the customers, such as a total number of renewal opportunities, a total number of high-risk renewal opportunities, a percentage of high-risk renewal opportunities, a total renewal target amount, a high-risk renewal target amount, and/or a percentage associated with the high-risk renewal target amount.

To facilitate analysis of data 236, management apparatus 206 may provide one or more filters 238 for data 236. For example, management apparatus 206 may display filters 238 for churn risk level 234, location, company size, company type, industry, renewal target amount, and/or other attributes in GUI 204. After one or more filters 238 are selected by the user, management apparatus 206 may use filters 238 to update ranking 220, chart 222, and/or data 236.

Finally, management apparatus 206 may provide one or more recommendations 240 for reducing high customer churn risk levels in GUI 204. For example, GUI 204 may identify one or more risk types associated with risk factors 232 and include information for engaging with customers to mitigate high churn risk levels based on the risk types. The information may also be customized to the company types and/or other attributes of the customers. For example, information related to one or more products purchased by a customer and/or the customer's usage of the product(s) may be included in a document or presentation to allow a sales professional to view the information and/or present the information to others. Consequently, the system of FIG. 2 may improve sales of products through the online professional network by predicting churn risk in customers of the products and providing mechanisms for identifying, managing, and mitigating risk factors 232 associated with the churn risk.

Those skilled in the art will appreciate that the system of FIG. 2 may be implemented in a variety of ways. First, analysis apparatus 202, GUI 204, management apparatus 206, and/or data repository 134 may be provided by a single physical machine, multiple computer systems, one or more virtual machines, a grid, one or more databases, one or more filesystems, and/or a cloud computing system. Analysis apparatus 202, GUI 204, and management apparatus 206 may additionally be implemented together and/or separately by one or more hardware and/or software components and/or layers.

Second, company features 224, spending features 226, usage features 228, and account features 230 may be obtained from a number of data sources. For example, data repository 134 may include data from a cloud-based data source such as a Hadoop Distributed File System (HDFS) that provides regular (e.g., hourly) updates to data associated with connections, people searches, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness.

Finally, statistical models 208 may be implemented using different techniques and/or used to generate churn risk 216, thresholds 218, churn risk level 234, and/or risk factors 232 in different ways. For example, churn risk 216 and/or thresholds 218 may be generated using a gradient tree boosting technique, while risk factors 232 may be identified using one or more additional decision trees. Other types of statistical models, such as artificial neural networks, Bayesian networks, support vector machines, and/or clustering techniques, may also be used with or in lieu of the gradient tree boosting technique and/or decision trees to provide the functionality of analysis apparatus 202. Alternatively, churn risk 216, thresholds 218, churn risk level 234, and/or risk factors 232 may be generated using the same statistical model instead of separate statistical models.

Statistical models 208 may further be updated based on subsequent behavior and/or spending by the customers. For example, renewal amounts, churn rates, and/or other attributes associated with the customers may be tracked after churn risk 216, thresholds 218, churn risk level 234, and/or risk factors 232 are identified for the customers. The attributes may then be provided as training data to statistical models 208, and the training data may be used to update weights, thresholds, and/or other elements used by statistical models 208 to predict churn risk 216 and identify risk factors 232 for the customers.

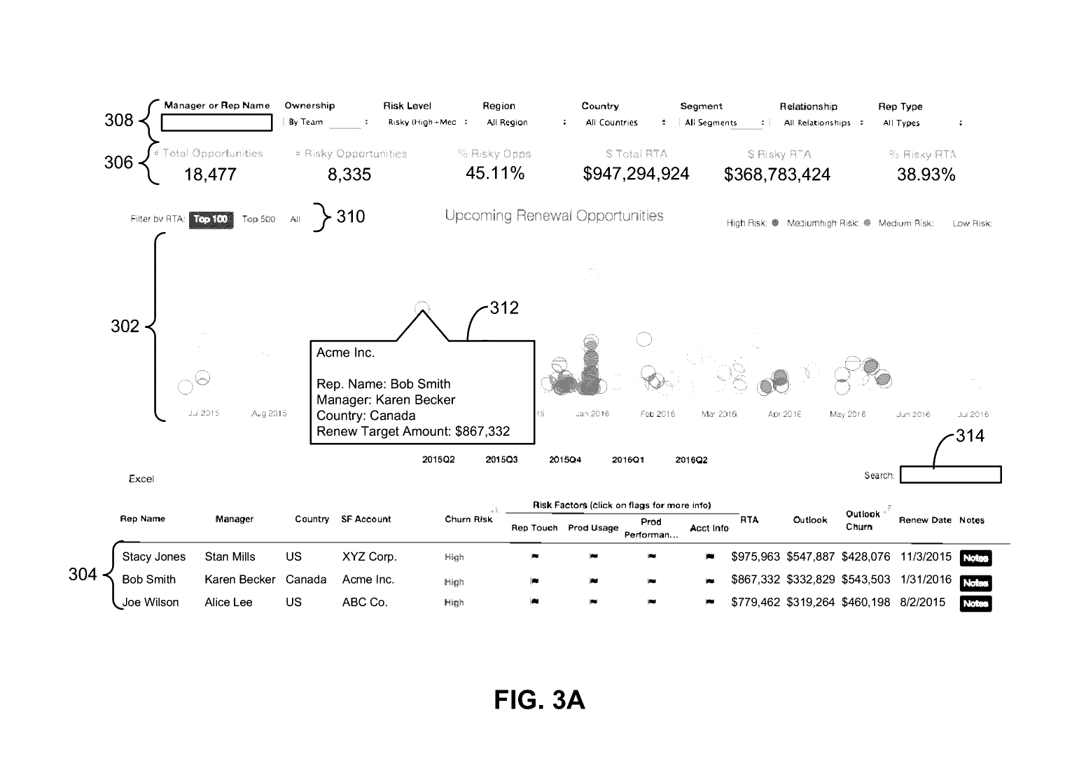

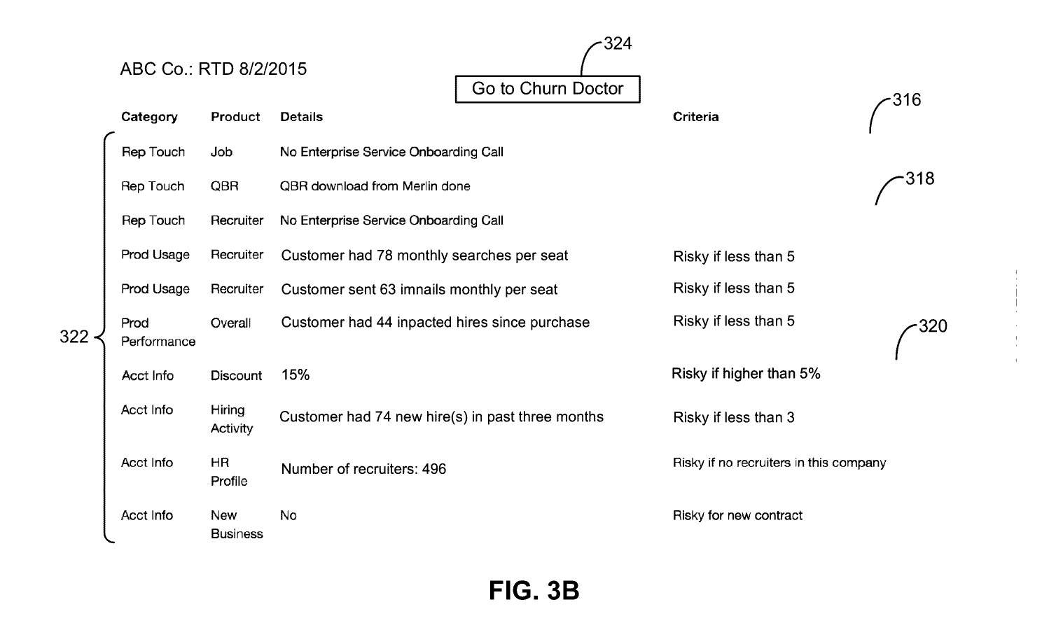

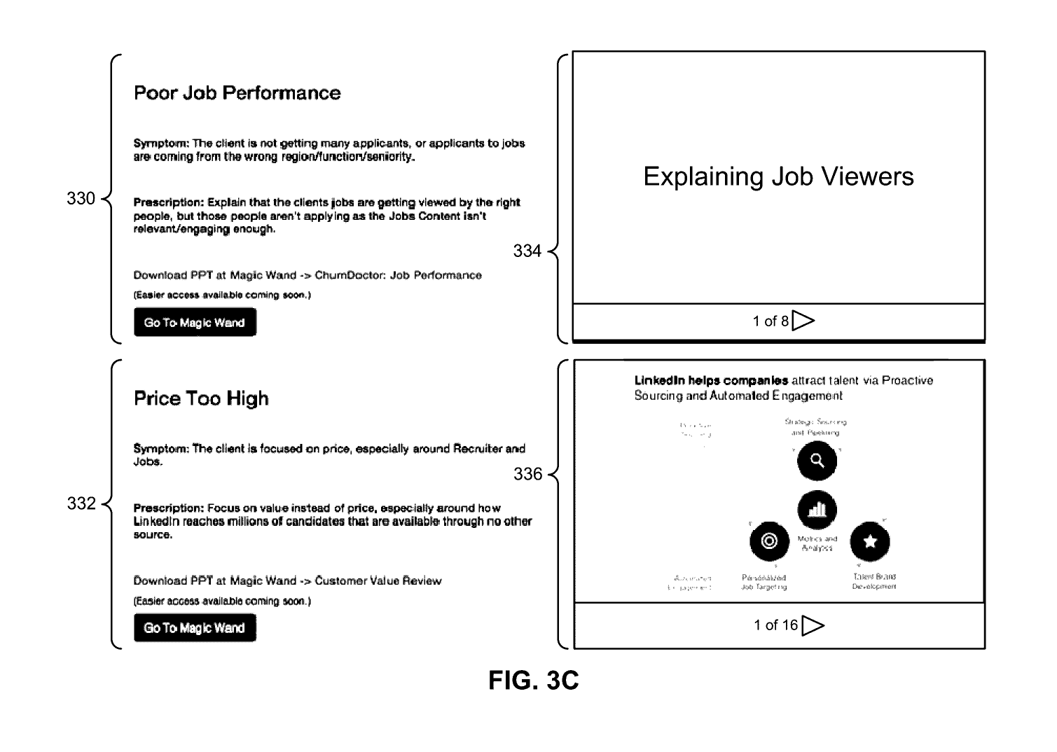

FIG. 3A shows an exemplary screenshot in accordance with the disclosed embodiments. More specifically, FIG. 3A shows a screenshot of a GUI, such as GUI 204 of FIG. 2. As mentioned above, the GUI may be used to identify and mitigate churn risk in customers of a product, such as a product that is accessed through an online professional network.

As shown in FIG. 3A, the GUI includes a chart 302 of renewal opportunities for the customers over an upcoming time interval. For example, chart 302 may show renewal opportunities over the upcoming year. Each renewal opportunity may be represented by a color-coded circle, with the color of the circle representing the churn risk level of the corresponding customer: red may indicate a high churn risk level, orange may indicate a medium-high churn risk level, yellow may indicate a medium churn risk level, and green may indicate a low churn risk level. The horizontal position of the renewal opportunity in chart 302 may represent the renewal date of the customer along the time interval, and the vertical position of the renewal opportunity in chart 302 may represent the renewal target amount of the customer.

The GUI may also include a table 304 of data for the customers. Columns of table 304 may specify the representative name, manager, country, account name, churn risk, risk factors (e.g., “Rep Touch,” “Prod Usage,” “Prod Performance,” “Acct Info”), renewal target amount (e.g., “RTA”), outlook (e.g., predicted renewal amount), outlook churn (e.g., difference between predicted renewal amount and renewal target amount), and/or renewal date of customer accounts for the customers. Rows of table 304 may be sorted by increasing or decreasing values in the columns of the table.

One or more portions of table 304 may link to other parts of the GUI. For example, a user may select a representative name, manager, and/or account name in table 304 to navigate to a screen containing information related to the selected entity. The user may also select a flag under the risk factors to view additional information related to the risk factors, as discussed below with respect to FIG. 3B. Finally, the user may select an element in the last column (e.g., “Notes”) of table 304 to navigate to a screen for entering input related to the customer represented by the element. For example, the user may select the element to provide notes on the customer and/or manually set the churn risk level of the customer after obtaining feedback from the customer. The notes and/or churn risk level may then be used to update one or more statistical models for predicting churn risk and/or identifying churn risk factors for customers.

Data used to populate table 304 may be aggregated into a set of statistics 306 for the customers, which are displayed above chart 302. For example, the number of customers may be represented by a value for “# Total Opportunities” (e.g., “18,477”), the number of customers with medium-high or high churn risk levels may be represented by a value for “# Risky Opportunities” (e.g., “8,335”), and the percentage of customers with medium-high or high churn risk levels may be represented by a value for “% Risky Opps” (e.g., “45.11%”). The renewal target amounts of the customers may be aggregated into a value for “$ Total RTA” (e.g., “$947,294,924”), the renewal target amounts of customers with medium-high or high churn risk levels may be aggregated into a value for “$ Risky RTA” (e.g., “$368,783,424”), and the percentage of the total renewal target amount from customers with medium-high or high churn risk levels may be aggregated into a value for “% Risky RTA” (e.g., “38.93%”).

Different views of data in chart 302, table 304, and/or statistics 306 may be generated by applying one or more filters 308-310 to the data. Filters 308 may include a manager or representative name, ownership (e.g., team, individual, etc.), churn risk level (e.g., all levels, high and medium-high, high, medium-high, medium, low), region, country, segment (e.g., enterprise, small business, global), customer relationship (e.g., corporate, global, hybrid, staffing), and/or representative type (e.g., corporate, global, hybrid, staffing, etc.). Filter 310 may include user-interface elements for specifying the top 100, top 500, or all customers that are ranked in decreasing order of renewal target amount. After a filter is specified using the corresponding user-interface element, chart 302, table, 304, and/or statistics 306 may be updated to contain data that matches the filter.

Similarly, data in table 304 may be updated using a search field 314. For example, a search term entered in search field 314 may restrict the rows in table 304 to those containing data that matches the search term.

Chart 304, table 304, and/or other parts of the GUI may further be updated based on the position of a cursor in the GUI. For example, chart 304 may include a user-interface element 312 that is adjacent to a representation of a renewal opportunity (e.g., a circle) in chart 304. User-interface element 312 may be displayed when the cursor is positioned over the renewal opportunity. Data in user-interface element 132 may include a customer name (e.g., “Acme Inc.”), a representative name (e.g., “Bob Smith”), a manager (e.g., “Karen Becker”), a country (e.g., “Canada”), and a renewal target amount (e.g. “$867,332”) for the renewal opportunity. As the cursor is moved over other circles in chart 302, the position of user-interface element 312 may shift to be adjacent to the circle over which the cursor is currently positioned, and values in user-interface element 312 may be updated to reflect data associated with the corresponding renewal opportunity.

Those skilled in the art will appreciate that chart 302, table 304, and/or user-interface element 312 may include other types and/or representations of information. For example, churn risk levels, renewal target amounts, and/or other attributes of renewal opportunities in chart 302 may be distinguished by shading, highlighting, line types, darkness, shape, size, and/or other visual attributes. Axes of chart 302 may also represent other dimensions, such as customer types, locations, and/or products. Chart 302 may further be a line chart, a pie chart, a bar chart, and/or other visualization of data associated with the churn risks of the customers. In a second example, table 304 and/or user-interface element 312 may include different types and/or representations of information related to churn risk in the customers.

FIG. 3B shows an exemplary screenshot in accordance with the disclosed embodiments. More specifically, FIG. 3B show a screenshot of the GUI of FIG. 3A after the user selects a flag under the risk factors in table 304, such as a flag in the third row of table 304. In response to the selected flag, the screen of FIG. 3B may be overlaid on the screen of FIG. 3A, or the GUI may navigate from the screen of FIG. 3A to the screen of FIG. 3B.

The GUI of FIG. 3B includes a list 322 of risk factors for the customer and renewal target date associated with the selected flag (e.g., “ABC Co.: RTD 8/2/2015”). One or more rows in the list may be color-coded, with green representing a lack of the corresponding risk factor in the customer and red representing a presence of the corresponding risk factor in the customer. Within the list, the risk factors may be identified by category, product, details (e.g., values of features associated with the risk factors), and criteria (e.g., thresholds used to identify the risk factors).

In particular, three rows 316-320 of list 322 may include risk factors associated with churn risk in the customer. Rows 316-318 may describe risk factors associated with a lack of an onboarding call for a newly signed customer, and row 320 may indicate that the customer received a 15% discount, and that a discount-based risk factor is present when the discount is higher than 5%. As a result, rows 316-318 may indicate a churn risk due to lack of contact with the customer after the customer signs, and row 320 may indicate a churn risk due to the signing of the customer at a higher discount than can be offered when the customer renews.

The GUI of FIG. 3B also includes a user-interface element 324 (e.g., “Go to Churn Doctor”). The user may select user-interface element 324 to navigate to a screen of the GUI that provides recommendations for mitigating one or more of the risk factors, as described in further detail below with respect to FIG. 3C.

FIG. 3C shows an exemplary screenshot in accordance with the disclosed embodiments. More specifically, FIG. 3C shows the GUI of FIG. 3B after the user has selected user-interface element 324. In response to the selected user-interface element 324, the GUI may show a set of user-interface elements 330-336 related to risk factors associated with churn risk in customers of a product such as a recruiting solution.

User-interface elements 330-332 may summarize different types of customer churn risk. For example, user-interface elements 330-332 may include names of the churn risk types, symptoms of the churn risk types, and/or prescriptions for addressing the churn risk types. User-interface elements 334-336 may provide detailed information for managing customers associated with the risk types identified in user-interface elements 330-332. For example, user-interface elements 334-336 may include slide decks that describe techniques for engaging with the customers and/or otherwise addressing issues associated with the risk types. In other words, the GUI of FIG. 3C may provide recommendations for reducing churn risk associated based on the risk types, which may be used by a sales professional to manage customer relationships and improve his/her sales performance.

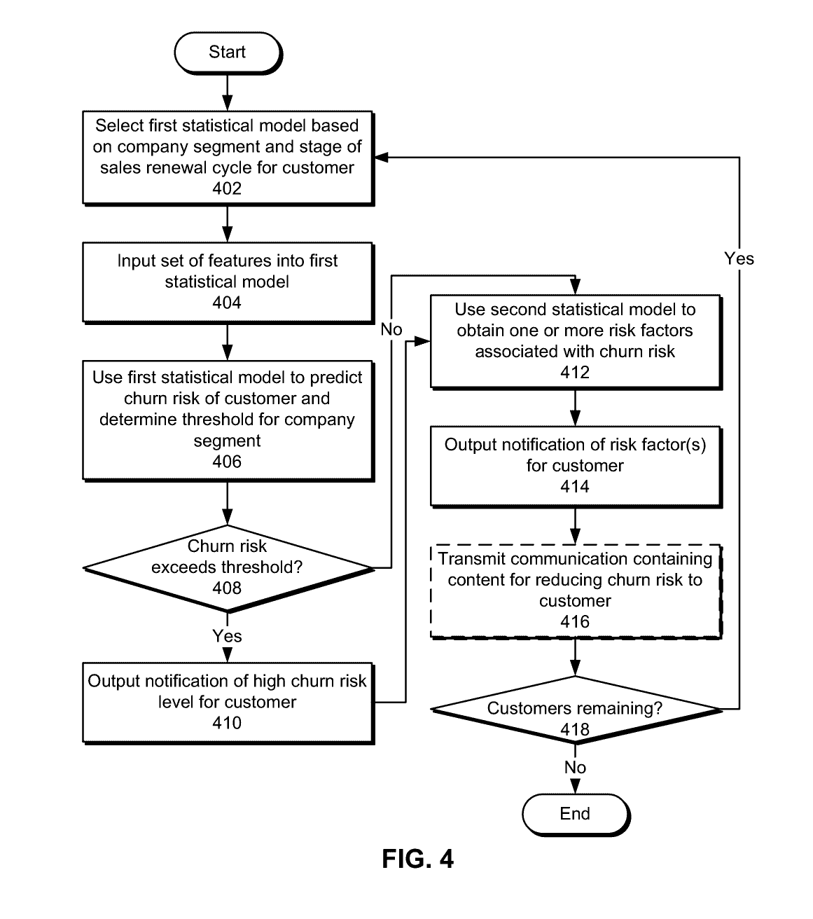

FIG. 4 shows a flowchart illustrating the processing of data in accordance with the disclosed embodiments. More specifically, FIG. 4 shows a flowchart of predicting and managing churn risk for customers of a product. In one or more embodiments, one or more of the steps may be omitted, repeated, and/or performed in a different order. Accordingly, the specific arrangement of steps shown in FIG. 4 should not be construed as limiting the scope of the embodiments.

Initially, a first statistical model is selected based on a company segment and a stage of a sales renewal cycle for a customer (operation 402) of the product. Next, a set of features is inputted into the first statistical model (operation 404). The set of features may include a company segment, which may include a company size, location, and/or company type of the customer. The set of features may also include an account feature, a usage feature, and/or a spending feature.

The statistical model is used to predict a churn risk of the customer and determine a threshold for the company segment (operation 406), and the churn risk is compared to the threshold (operation 408) to determine if the customer has a high churn risk level. For example, the statistical model may use a gradient boosting tree technique to generate a numeric churn risk score for the customer from the features. The statistical model may select the threshold for the churn risk based on the distribution of churn risk scores and/or other attributes associated with customers in the same company segment and stage of the sales renewal cycle. If the churn risk does not exceed the threshold, the high churn risk level is not found in the customer.

If the churn risk exceeds the threshold, the high churn risk level is identified in the customer. In turn, a notification of the high churn risk level for the customer is outputted (operation 410). For example, the high churn risk level may be included in an email, message, alert, GUI, and/or other notification. If the churn risk does not exceed the threshold, the high churn risk level is not identified in the customer, and the notification may be omitted.

A second statistical model is then used to obtain one or more risk factors associated with the churn risk (operation 412), independently of the churn risk level of the customer. For example, the statistical model may use one or more decision trees to compare a subset of the features for the customer to a number of thresholds. When a feature does not meet a given threshold, the corresponding risk factor is identified in the customer.

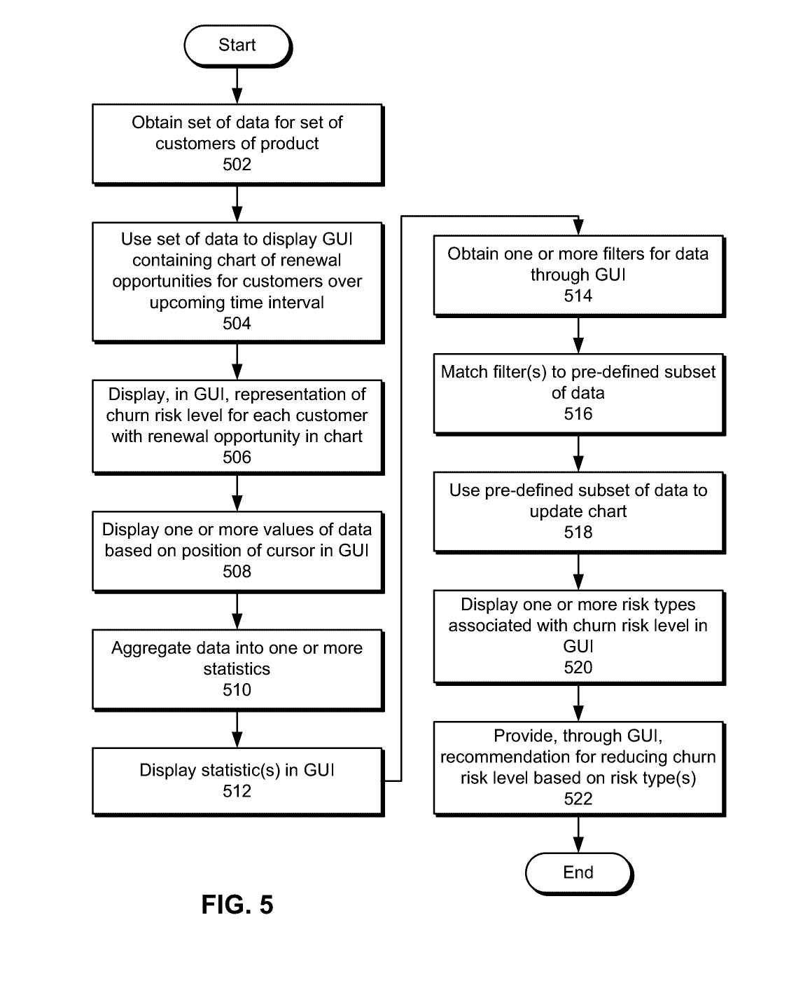

A notification of the risk factor(s) is also outputted (operation 414). For example, the risk factor(s) may be provided in an email, message, alert, and/or other notification along with the churn risk level of the customer. Alternatively, the risk factor(s) may be included in an additional notification that is separate from a notification of the customer's churn risk level. The churn risk level and risk factor(s) may also (or instead) be displayed in a GUI, as described in further detail below with respect to FIG. 5. In addition, a communication containing content for reducing the churn risk is optionally transmitted to the customer (operation 416). For example, a risk factor associated with sub-optimal results experienced by the customer with the product may be mitigated by engaging the customer with marketing content that addresses a number of potential sources of the sub-optimal results.

Churn risk may continue to be analyzed for remaining customers (operation 418) of the product. If the churn risk is to be analyzed for a customer, the churn risk is predicted by a first statistical model related to the customer and compared to the threshold (operations 402-408) representing a high churn risk level. If the churn risk does not exceed the threshold, additional analysis of the customer's features may be omitted. If the churn risk exceeds the threshold, a second statistical model is used to obtain risk factor(s) associated with the customer's high churn risk level (operation 410), and notifications and/or communications associated with the customer's churn risk are outputted (operations 410-416). Analysis and management of churn risk may thus be performed for all customers of the product.

FIG. 5 shows a flowchart illustrating the process of providing a graphical user interface (GUI) on a computer system in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

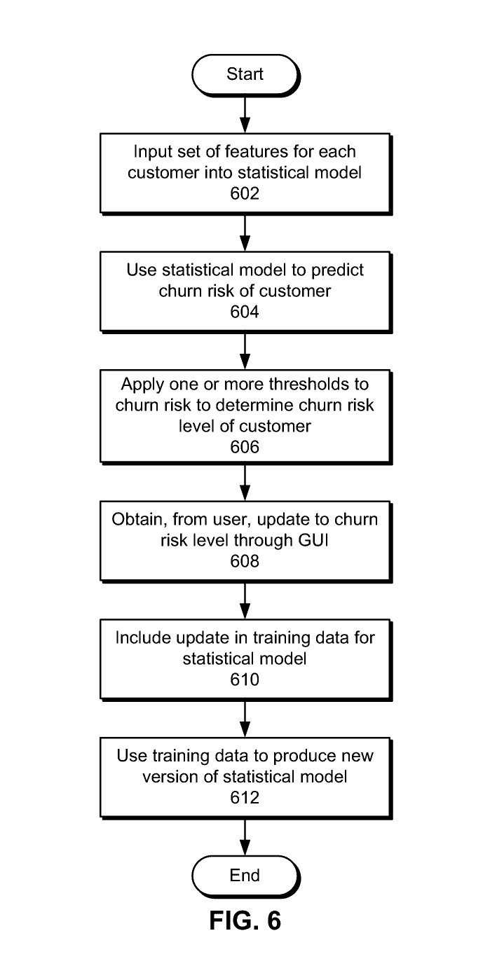

First, a set of data for a set of customers of a product is obtained (operation 502). The data may include a set of churn risk levels for the customers that is calculated using a statistical model, as described in further detail below with respect to FIG. 6. Next, the data is used to display a GUI containing a chart of renewal opportunities for the customers over an upcoming time interval (operation 504), along with a representation of the churn risk level for each customer with a renewal opportunity in the chart (operation 506). For example, the chart may include symbols representing the renewal opportunities, which are color-coded to indicate the churn risk levels of the corresponding customers.

One or more values of the data are also displayed based on the position of the cursor in the GUI (operation 508). For example, a customer name, location, renewal target amount, and/or renewal date of a customer may be displayed next to a symbol representing a renewal opportunity for the customer in a chart when the cursor is positioned over the symbol. In another example, positioning of the cursor over a symbol of a risk factor for the customer (e.g., a flag) and/or selecting the symbol using the cursor may result in the display of one or more risk factors associated with the churn risk level of the customer and/or one or more criteria used to identify the risk factors.

The data is additionally aggregated into one or more statistics (operation 510) that are displayed in the GUI (operation 512). For example, the data may be aggregated into a number of renewal opportunities, a number of high-risk renewal opportunities, a percentage of the high-risk renewal opportunities, a total renewal target amount, a high-risk renewal target amount, and/or a percentage associated with the high-risk renewal target amount.

One or more filters for the data are obtained through the GUI (operation 514). The filters may include churn risk level, location, company size, industry, and/or renewal target amount. Next, the filters are matched to a pre-defined subset of the data (operation 516), and the pre-defined subset of the data is used to update the chart (operation 518). For example, data used to populate the chart and/or other parts of the GUI may be retrieved using a single query that contains all combinations of filters. As a result, the query may be used to obtain multiple subsets of the data, which are matched to the filters obtained in operation 514 and used to generate various components of the GUI in lieu of running a separate query each time a different set of filters is specified.

Finally, one or more risk types associated with the churn risk level are displayed in the GUI (operation 520), and a recommendation for reducing the churn risk level based on the risk type(s) is provided through the GUI (operation 522). For example, the risk types may identify certain risk factors or groups of risk factors that may contribute to a high churn risk level in a customer, and the recommendation may include information for addressing customer issues associated with the risk factors. By following the recommendation, a sales professional may engage with the customer in a way that reduces the customer's churn risk and improves the sales performance of the sales professional.

FIG. 6 shows a flowchart illustrating the process of obtaining a set of churn risk levels for a set of customers of a product in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a set of features for each customer is inputted into a statistical model (operation 602), and the statistical model is used to predict the churn risk of the customer (operation 604). For example, features for a number of customers in a given company segment and stage of a sales renewal cycle may be provided to the statistical model, and the statistical model may generate a set of numeric scores for the customers from the features.

Next, one or more thresholds are applied to the churn risk to determine the churn risk level of the customer (operation 606). For example, the thresholds may be applied to the churn risk to identify the customer's churn risk level as high, medium-high, medium, or low. As mentioned above, the thresholds may be provided by the statistical model based on a distribution of churn risks for the customers and/or other attributes associated with the customers.

An update to the churn risk level is then obtained from a user through a GUI (operation 608). For example, the user may use the GUI to manually revise the churn risk level of the customer from high to medium after obtaining feedback from the customer indicating the customer's willingness to renew. The update is included in training data for the statistical model (operation 610), and the training data is used to produce a new version of the statistical model (operation 612). For example, a manually revised churn risk level for the customer may be provided to the statistical model to update the calculation of churn risk and/or churn risk levels by the statistical model. As a result, the update may improve the accuracy of the statistical model in generating subsequent churn risks and/or churn risk levels for the customers.

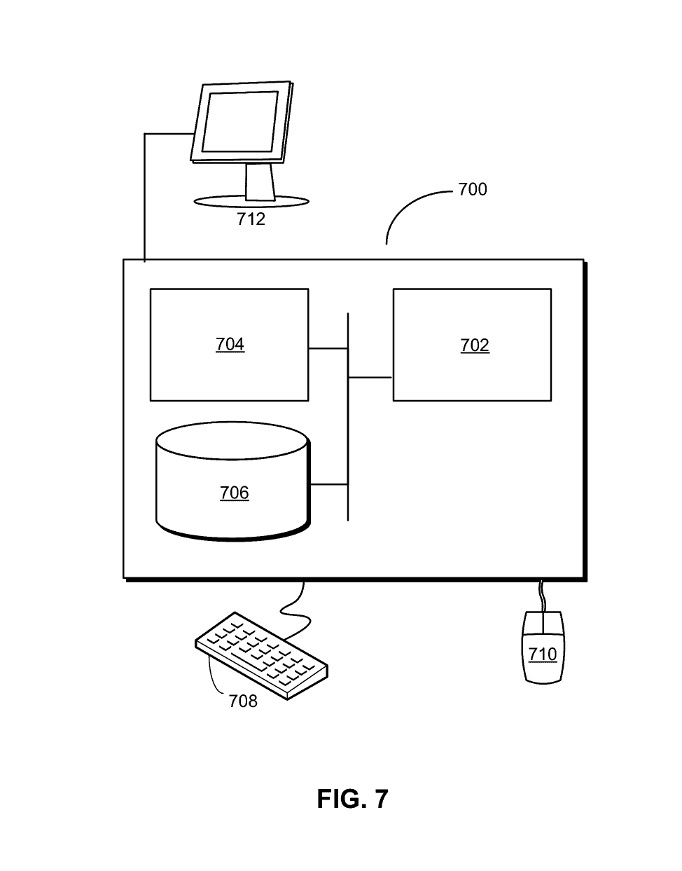

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for processing data. The system may include an analysis apparatus that inputs a set of features for a customer of a product, including a company segment of the customer, into a first statistical model. Next, the analysis apparatus may use the first statistical model to predict a churn risk of the customer and identify a high churn risk level in the customer when the churn risk exceeds a threshold.

The system may also include a management apparatus that outputs a notification of the high churn risk level for the customer. The management apparatus may also display a GUI containing a chart of renewal opportunities for a set of customers over an upcoming time interval. The management apparatus may further display a representation of a churn risk level for each of the customers with a renewal opportunity in the chart. The analysis apparatus and/or management apparatus may further obtain an update to the churn risk level of the customer through the GUI, include the update in training data for the statistical model, and use the training data to produce a new version of the statistical model.

In addition, one or more components of computer system 700 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that predicts and manages churn risk for a set of remote customers.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A method, comprising:
obtaining a set of data for a set of customers of a product, wherein the set of data comprises a set of churn risk levels for the customers;
using the set of data to display, by a computer system, a graphical user interface (GUI) comprising a chart of renewal opportunities with the set of customers, for the product, over an upcoming time interval; and
displaying, in the GUI, a representation of a churn risk level for each customer in the set of customers with a renewal opportunity in the chart.

2. The method of claim 1, further comprising:
displaying one or more values of the data based on a position of a cursor in the GUI.

3. The method of claim 2, wherein the one or more values comprise:
a customer name;
a location;
a renewal target amount; and
a renewal date.

4. The method of claim 2, wherein the one or more values comprise:
one or more risk factors associated with the churn risk level; and
one or more criteria used to identify the one or more risk factors.

5. The method of claim 1, further comprising:
obtaining one or more filters for the data from a user through the GUI;
matching the one or more filters to a pre-defined subset of the data; and
using the pre-defined subset of the data to update the chart.

6. The method of claim 5, wherein the one or more filters comprise at least one of:
the churn risk level;
a location;
a company size;
an industry; and
a renewal target amount.

7. The method of claim 1, further comprising:
aggregating the data into one or more statistics; and
displaying the one or more statistics in the GUI.

8. The method of claim 7, wherein the one or more statistics comprise at least one of:
a number of renewal opportunities;
a number of high-risk renewal opportunities;
a percentage of high-risk renewal opportunities;
a total renewal target amount;
a high-risk renewal target amount; and
a percentage associated with the high-risk renewal target amount.

9. The method of claim 1, wherein obtaining the set of data for the set of customers comprises:
inputting a set of features for a customer of the product into a statistical model, wherein the set of features comprises a company segment of the customer;
using the statistical model to predict a churn risk of the customer; and
applying one or more thresholds to the churn risk to determine the churn risk level of the customer.

10. The method of claim 10, wherein obtaining the set of data for the set of customers further comprises:
obtaining, from a user, an update to the churn risk level of the customer through the GUI;
including the update in training data for the statistical model; and
using the training data to produce a new version of the statistical model.

11. The method of claim 1, further comprising:
displaying, in the GUI, one or more risk types associated with the churn risk level; and
providing, through the GUI, a recommendation for reducing the churn risk level based on the one or more risk types.

12. An apparatus, comprising:
one or more processors; and
memory storing instructions that, when executed by the one or more processors, cause the apparatus to:
obtain a set of data for a set of customers of a product, wherein the set of data comprises a set of churn risk levels for the customers;
using the set of data to display a graphical user interface (GUI) comprising a chart of renewal opportunities with the set of customers, for the product, over an upcoming time interval; and
display, in the GUI, a representation of a churn risk level for each customer in the set of customers with a renewal opportunity in the chart.

13. The apparatus of claim 12, wherein the memory further stores instructions that, when executed by the one or more processors, cause the apparatus to:
display one or more values of the data based on a position of a cursor in the GUI.

14. The apparatus of claim 13, wherein the one or more values comprise:
a customer name;
a location;
a renewal target amount; and
a renewal date.

15. The apparatus of claim 13, wherein the one or more values comprise:
one or more risk factors associated with the churn risk level; and
one or more criteria used to identify the one or more risk factors.

16. The apparatus of claim 12, wherein the memory further stores instructions that, when executed by the one or more processors, cause the apparatus to:
obtain one or more filters for the data from a user through the GUI;
match the one or more filters to a pre-defined subset of the data; and
use the pre-defined subset of the data to update the chart.

17. The apparatus of claim 16, wherein the one or more filters comprise at least one of:
the churn risk level;
a location;
a company segment;
a company size;
an industry; and
a renewal target amount.

18. The apparatus of claim 12, wherein obtaining the set of data for the set of customers comprises:
inputting a set of features for a customer of the product into a statistical model, wherein the set of features comprises a company segment of the customer;
using the first statistical model to predict a churn risk of the customer; and
applying one or more thresholds to the churn risk to determine the churn risk level of the customer.

19. A system, comprising:
an analysis non-transitory computer-readable medium comprising instructions that, when executed by one or more processors, cause the system to obtain a set of data for a set of customers of a product, wherein the set of data comprises a set of churn risk levels for the customers; and
a management non-transitory computer-readable medium comprising instructions that, when executed by one or more processors, cause the system to:
use the set of data to display a graphical user interface (GUI) comprising a chart of renewal opportunities with the set of customers, for the product, over an upcoming time interval; and
display, in the GUI, a representation of a churn risk level for each customer in the set of customers with a renewal opportunity in the chart.

20. The system of claim 19, wherein obtaining the set of data associated with the churn risk for the set of customers comprises:
inputting a set of features for a customer of the product into a statistical model, wherein the set of features comprises a company segment of the customer;
using the first statistical model to predict a churn risk of the customer; and
applying one or more thresholds to the churn risk to determine the churn risk level of the customer.
